(19) United States
(12) Patent Application Publication
(10) Pub. No.: US 2019/0206048 A1
(43) Pub. Date: Jul. 4, 2019

(54) METHOD AND SYSTEM FOR ANALYSIS OF RESIDENTIAL POOL CONDITION TO EVALUATE QUALITY OF OWNERSHIP OF A SWIMMING FACILITY

(71) Applicant: Galen Crabtree, Oklahoma City, OK (US)

(72) Inventor: Galen Crabtree, Oklahoma City, OK (US)

(21) Appl. No.: 15/859,373

(22) Filed: Dec. 30, 2017

(51) Int. Cl. G06T 7/00; G06F 17/30; G06K 9/72

(52) U.S. Cl. CPC G06T 7/0006; G06Q 50/16; G06K 9/72; G06F 17/30259

(57) ABSTRACT

Disclosed are a method and/or a system for analysis of a residential pool condition to evaluate a quality of ownership of a swimming facility. In one embodiment, a method automatic evaluates a design of a residential pool through an image recognition algorithm. The design includes finishes, plumbing, safety standards, maintenance parameters, and/or mechanical features in relation to a defined set of state-of-art technologies then available. The method generates a numerical score to inform y about relative quality of ownership based on the defined set of state-of-art technologies then available.

### FIELD OF TECHNOLOGY

The present disclosure relates generally to pool maintenance technique, and more particularly, to method and/or system for analysis of residential pool condition to evaluate quality of ownership of a swimming facility.

### BACKGROUND

A swimming pool may be a structure designed to hold water to enable swimming and/or other leisure activities. The swimming pool may be built into the ground (in-ground pools) or built above ground (as a freestanding construction or as part of a building or other larger structure. In-ground pools may be constructed from materials such as concrete, natural stone, metal, plastic and/or fiberglass, and may be built in a variety of sizes and configurations. As technology evolves, swimming pools may be built with more connectivity, features, and techniques.

Some residential homes may have swimming pools in their backyard. However, it may be difficult to determine whether a particular swimming pool is more desirable over any other particular swimming pool. Therefore, an interested party (e.g., an owner, a resident, a seller, an agent, a buyer) may have no way of qualifying how a particular pool is comparable with other homes having pools or with the current state of the art.

### SUMMARY

The disclosed invention presents a method and/or a system for analysis of a residential pool condition to evaluate a quality of ownership of a swimming facility. In one aspect, a method automatic evaluates a design of a residential pool through an image recognition algorithm. The design includes finishes, plumbing, safety standards, maintenance parameters, and/or mechanical features in relation to a defined set of state-of-art technologies then available. The method generates a numerical score to inform an interested party about relative quality of ownership based on the defined set of state-of-art technologies then available.

A historical database may be maintained of materials, repairs, modifications and/or improvements during a history of the residential pool. The interested party may be a buyer, a homeowner, a prospective buyer, a resident, and/or a seller of the residential pool. In addition, the method includes analysis of a pictorial data of the residential pool using the image recognition algorithm.

The method may fetch a set of technical parameters of the residential pool based on the analysis of the pictorial data using the image recognition algorithm. The method may identify the different equipment installed in the residential pool using the image recognition algorithm. In addition, the method may automatically identify a shape, a length, a width, a depth, a linear finish, flooring, a plumbing, a set of electrical equipment, a drain location, an overflow pipe location, and a handrail location based on the image recognition algorithm.

In another aspect, a computer-implemented method of measuring a quality of ownership of a residential pool receives a constructed response generated by a user. The constructed response is based on a picture of the residential pool. The computer-implemented method of measuring a quality of ownership of a residential pool parses the constructed response with a processing system. The parsing the constructed response with a processing system generates a set of individual characteristics associated with the constructed response.

The computer-implemented method of measuring a quality of ownership of a residential pool processes the constructed response with the processing system. The constructed response processes with a processing system to identify a plurality of multi-word sequences, each multi -word sequence including a sequence of two or more adjacent words in the constructed response. The constructed response processes with a processing system to determine a first numerical measure indicative of a presence of one or more quality of ownership scores.

The computer-implemented method of measuring a quality of ownership of a residential pool processes the set of individual characteristics and a reference corpus with the processing system to determine a second numerical measure indicative of a degree. The constructed response describes a subject matter of the picture. Each word of the set of individual characteristics is compared to individual words of the reference corpus to determine the second numerical measure. The reference corpus is designated as representative of the subject matter.

The computer-implemented method of measuring a quality of ownership of a residential pool processes the plurality of multi-word sequences of the constructed response and a comparable pool dataset including a plurality of entries with the processing system. The processing of the plurality of multi-word sequences constructed response and the comparable pool dataset determines a third numerical measure indicative of a degree of pool irregularity factors in the constructed response. Each of the multi-word sequences of the constructed response is searched across the entries of the comparable pool dataset to determine the third numerical measure.

Each entry of the comparable pool dataset includes an English word n-gram and an associated statistical association score, The searching of each multi-word sequence includes comparing the multi-word sequence of the constructed response to English word n-grams of the comparable pool dataset. The comparison of the multi-word sequence to English word n-grams of the comparable pool dataset determines a matching entry of the comparable pool dataset. The statistical association score for the matching entry indicating a probability of the multi-word sequence appearing in a well-formed text.

The computer-implemented method of measuring a quality of ownership of a residential pool applies a numerical computer-based scoring model to the first numerical measure, the second numerical measure, and the third numerical measure to automatically determine the quality of ownership score for the constructed response indicative of a desirability of the residential pool. The quality of ownership score is based on a defined set of state-of-art technologies then available. The numerical computer-based scoring model includes a first variable and an associated first weighting factor, the first variable receiving a value of the first numerical measure, a second variable and an associated second weighting factor, the second variable receiving a value of the second numerical measure, and a third variable and an associated third weighting factor, the third variable receiving a value of the third numerical measure.

The computer-implemented method of measuring a quality of ownership of a residential pool automatically evaluates a design of the residential pool through the numerical computer -based scoring model. The design includes finishes, plumbing, safety standards, maintenance parameters and/or mechanical features in relation to a defined set of state-of-art technologies then available.

The determining of the second numerical measure may include processing the set of individual characteristics and. a pool image database. The processing the set of individual characteristics and a pool image database may generate an expanded set of individual characteristics, the expanded set includes synonyms, hyponyms, and/or hypernyms of the individual words. The determining of the second numerical measure may include processing the reference corpus and the pool image database. Processing the reference corpus and the pool image database may generate an expanded reference corpus, the expanded reference corpus includes synonyms, hyponyms, and/or hypernyms of individual words included in the reference corpus.

The determining second numerical measure may include determining a first metric for the constructed response. The first metric may indicate a percentage of words of the set of individual characteristics that are included in the reference corpus. The determining of the second numerical measure may include determining a second metric for the constructed response. The second metric indicating a percentage of words of the expanded set of individual characteristics that are included in the expanded reference corpus.

The computer-implemented method may include upsampling of the picture of the residential pool using a non-linear fully connected network to produce only global details of an upsampled image. The computer-implemented method may interpolate a resulting image to produce a smooth upsampled image. The computer-implemented method may concatenate the global details and the smooth upsampled image into a tensor. The computer-implemented method may apply a sequence of nonlinear convolutions to the tensor using a convolutional neural network to produce the upsampled image. The steps of the method may be performed by a processor.

The fully connected network, an interpolation, and a convolution may be concurrently trained to reduce an error between upsampled set of images and corresponding set of high -resolution images. The fully connected network may be a neural network. The training may produce weights for each neuron of the neural network. The interpolation may use different weights for interpolating different pixels of the image. The training may produce the different weights of the interpolation. The training may produce weights for each neuron of the sequence of nonlinear convolutions. The computer-implemented method may further include padding each nonlinear convolution in the sequence to the resolution of the upsampled image.

In yet another aspect, a computer system measuring a quality of ownership of a residential pool using a processor and a. memory. The instructions stored in the memory configure the processor receives a constructed response generated by a user. The constructed response is based on a picture of the residential pool. The instructions stored in the memory configure the processor parses the constructed response with a processing system to generate a set of individual characteristics associated with the constructed response. The instructions stored in the memory configure the processor to process the constructed response with the processing system to identify in the constructed response a plurality of multi-word sequences, each multi -word sequence.

The instructions stored in the memory configure the processor to process the constructed response with the processing system to determine a first numerical measure indicative of a presence of one or more quality of ownership scores in the constructed response. The instructions stored in the memory configure the processor to process the set of individual characteristics and a reference corpus with the processing system to determine a second numerical measure indicative of a degree to which the constructed response describes a subject matter of the picture. Each word of the set of individual characteristics is compared to individual words of the reference corpus to determine the second numerical measure. The reference corpus is designated as representative of the subject matter.

The instructions stored in the memory configure the processor to process the plurality of multi-word sequences of the constructed response and a comparable pool dataset includes a plurality of entries with the processing system to determine third numerical measure indicative of a degree of pool irregularity factors in the constructed response. Each of the multi-word sequences of the constructed response is searched across the entries of the comparable pool dataset to determine the thud numerical measure. Each entry of the comparable pool dataset includes an English word n-gram and an associated statistical association score. The searching of each multi-word sequence includes comparing the multi-word sequence of the constructed response to English word n-grams of the comparable pool dataset to determine a matching entry of the comparable pool dataset. The statistical association score for the matching entry indicating a probability of the multi-word sequence appearing in a well-formed text.

The instructions stored in the memory configure the processor applies a numerical computer-based scoring model to the first numerical measure, the second numerical measure, and the third numerical measure to automatically determine a quality of ownership score for the constructed response indicative of a desirability of the residential pool. The quality of ownership score based on a defined set of state-of-art technologies then available. The numerical computer -based scoring model includes a first variable and an associated first weighting factor, the first variable receiving a value of the first numerical measure, a second variable and an associated second weighting factor, the second variable receiving a value of the second numerical measure, and a third variable and an associated third weighting factor, the third variable receiving a value of the third numerical measure.

The instructions stored in the memory configure the processor automatically evaluates a design of the residential pool through the numerical computer-based scoring model. The design includes finishes, plumbing, safety standards, maintenance parameters and/or mechanical features in relation. to a defined set of state-of-art technologies then available.

The computer system may measure the quality of ownership of the residential pool using the processor and the memory. The instructions stored in the memory may configure the processor to process the set of individual characteristics and a pool image database to generate an expanded set of individual characteristics, the expanded set includes synonyms, hyponyms, and/or hypernyms of the individual words. The instructions stored in the memory may configure the processor to process the reference corpus and the pool image database to generate an expanded reference corpus, the expanded reference corpus includes synonyms, hyponyms, and/or hypernyms of individual words included in the reference corpus.

The instructions stored in the memory may configure the processor to determine a first metric for the constructed response, the first metric indicating a percentage of words of the set of individual characteristics that are included in the reference corpus. The instructions stored in the memory may configure the processor to determine a second metric for the constructed response, the second indicating a percentage of words of the expanded set of individual characteristics that are included in the expanded reference corpus.

The methods, devices, and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

The embodiments of this disclosure are illustrated by way of example and not limitation in the figures of the accompanying drawings, in which like references indicate similar elements and in which:

FIG. 1 is a conceptual view of a processing system to identify a PF classification and to generate a quality of ownership score for a residential pool, according to one embodiment.

FIG. 2 is a quality of ownership score range table view of the residential pool of FIG. 1, according to one embodiment.

FIG. 3 is a network view of the processing system of FIG. 1 receiving an analysis request of the residential pool sent by an interested party and communicating the analysis based on generated result, according to one embodiment.

FIG. 4 is an overview of the residential pool system of FIG. 1, according to one embodiment.

FIG. 5 is an operational view of the processing system of FIG. 1 to generate the quality of ownership score, according to one embodiment.

FIG. 6 is a process flow detailing the operations involving in evaluating a design and calculating the quality of ownership score of the residential pool of FIG. 1, according to an embodiment.

FIG. 7 is a user interface view displaying the statistics of the residential pool of FIG. 1 received to a computing device of the interested party, according to one embodiment.

Other features of the present embodiments will be apparent from accompanying drawings and from the disclosure that follows.

### DETAILED DESCRIPTION

The disclosed is a method and/or a system for analysis of a residential pool 324 condition to evaluate a quality of ownership (e.g., quality of ownership score 108) of a swimming facility (e.g., residential pool 102). In one embodiment, a method automatic evaluates a design of a residential pool 322 through an image recognition algorithm 318. The design (e.g., design characteristics 308) includes finishes 400, plumbing 402, safety standards, maintenance parameters, and/or mechanical features in relation to a defined set of state-of-art technologies then available. The method generates a numerical score (e.g., PF classification 106 and quality of ownership score 108) to inform an interested party 302 about relative quality of ownership (e.g., quality of ownership score 108) based on the defined set of state-of-art technologies then available.

A historical database 316 may be maintained of materials, repairs, modifications and/or improvements during a history of the residential pool. The interested party 302 may be a buyer, a homeowner, a prospective buyer, a resident, and/or a seller of the residential pool. In addition, the method includes analysis of a pictorial data (e.g., using pictorial data analysis module 310) of the residential pool 102 using the image recognition algorithm 318.

The method may fetch a set of technical parameters of the residential pool 102 based on the analysis of the pictorial data (e.g., pictorial data analysis module 310) using the image recognition algorithm 318. The method may identify the different equipment (e.g., plumbing 402, filter 404, pump 406, multiport valve 408, skimmer 410, regulation and control equipment 412, heater 414, dosing pump 416, inlet nozzle 418, automatic pool cleaner 420, hose 422, main drain 424 etc.) installed in the residential pool 102 using the image recognition algorithm 318. In addition, the method may automatically identify a shape 702, a length 704, a width 706, a depth 708, a linear finish (e.g., pool finishes 714), flooring (e.g., type of flooring 712), a plumbing 402, a set of electrical equipment, a drain location (e.g., main drain 424), an overflow pipe location, and a handrail location based on the image recognition algorithm 318.

In another embodiment, a computer-implemented method of measuring a quality of ownership (e.g., quality of ownership score 108) of a residential pool 102 receives a constructed response 306 generated by a user (e.g., interested party 302). The constructed response 306 is based on a picture (e.g., generated by interested party 302) of the residential pool 102. The computer-implemented method of measuring a quality of ownership (e.g., quality of ownership score 108) of a residential pool 102 parses the constructed response 306 with a processing system 100. The parsing the constructed response 306 with the processing system 100 generates a set of individual characteristics (e.g., design characteristics 308) associated with the constructed response 306.

The computer-implemented method of measuring a quality of ownership (e.g., quality of ownership score 108) of a residential pool 102 processes the constructed response 306 with the processing system 100. The constructed response 306 processes with the processing system 100 to identify a plurality of multi-word sequences, each multi-word sequence including a sequence of two or more adjacent words in the constructed response 306. The constructed response 306 processes with a processing system 100 to determine a first numerical measure indicative of a presence of one or more quality of ownership scores 108.

The computer-implemented method of measuring a quality of ownership (e.g., quality of ownership score 108) of a residential pool 102 processes the set of individual characteristics (e.g., design characteristics 308) and a reference corpus with the processing system 100 to determine a second numerical measure indicative of a degree. The constructed response 306 describes a subject matter of the picture (e.g., constructed response 306). Each word of the set of individual characteristics (e.g., design characteristics 308) is compared to individual words of the reference corpus to determine the second numerical measure. The reference corpus is designated as representative of the subject matter (e.g., constructed response 306).

The computer-implemented method of measuring a quality of ownership (e.g., quality of ownership score 108) of a residential pool 102 processes the plurality of multi-word sequences of the constructed response 306 and a comparable pool dataset (e.g., historical database 316) including a plurality of entries with the processing system 100. The processing of the plurality of multi-word sequences of the constructed response 306 and the comparable pool dataset (e.g., historical database 316) determines a third numerical measure indicative of a degree of pool (e.g., residential pool 102) irregularity factors in the constructed response 306. Each of the multi-word sequences of the constructed response 306 is searched across the entries of the comparable pool dataset (e.g., historical database 316) to determine the third numerical measure.

Each entry of the comparable pool dataset (e.g., historical database 316) includes an English word n-gram and an associated statistical association score (e.g., quality of ownership score 108). The searching of each multi-word sequence includes comparing the multi-word sequence of the constructed response 306 to English word n-grams of the comparable pool dataset (e.g., historical database 316). The comparison of the multi-word sequence to English word n-grams of the comparable pool dataset (e.g., historical database 316) determines a matching entry of the comparable pool dataset (e.g., historical database 316). The statistical association score (e.g., quality of ownership score 108) for the matching entry indicating a probability of the multi-word sequence appearing in a well-formed text.

The computer-implemented method of measuring a quality of ownership (e.g., quality of ownership score 108) of a residential pool 102 applies a numerical computer-based scoring model (e.g., score generator 320) to the first numerical measure, the second numerical measure, and the third numerical measure to automatically determine the quality of ownership score 108 for the constructed response 306 indicative of a desirability of the residential pool 102. The quality of ownership score 108 is based on a defined set of state-of-art technologies then available. The numerical computer-based scoring model (e.g., score generator 320) includes a first variable and an associated first weighting factor, the first variable receiving a value of the first numerical measure, a second variable and an associated second weighting factor, the second variable receiving a value of the second numerical measure, and a third variable and an associated third weighting factor, the third variable receiving a value of the third numerical measure.

The computer-implemented method of measuring a quality of ownership (e.g., quality of ownership score 108) of a residential pool 102 automatically evaluates a design of the residential pool 322 through the numerical computer-based scoring model (e.g., score generator 320). The design (e.g., design characteristics 308) includes finishes 400, plumbing 402, safety standards, maintenance parameters, and/or mechanical features in relation to a defined set of state-of-art technologies then available.

The determining of the second numerical measure may include processing the set of individual characteristics (e.g., design characteristics 308) and a pool image database (e.g., historical database 316). The processing the set of individual characteristics (e.g., design characteristics 308) and a pool image database (e.g., historical database 316) may generate an expanded set of individual characteristics (e.g., design characteristics 308), the expanded set includes synonyms, hyponyms, and/or hypernyms of the individual words. The determining of the second numerical measure may include processing the reference corpus and the pool image database (e.g., historical database 316). Processing the reference corpus and the pool image database (e.g., historical database 316) may generate an expanded reference corpus, the expanded reference corpus includes synonyms, hyponyms, and/or hypernyms of individual words included in the reference corpus.

The determining the second numerical measure may include determining a first metric for the constructed response 306. The first metric may indicate a percentage of words of the set of individual characteristics (e.g., design characteristics 308) that are included in the reference corpus. The determining of the second numerical measure may include determining a second metric for the constructed response 306. The second metric indicating a percentage of words of the expanded set of individual characteristics (e.g., design characteristics 308) that are included in the expanded reference corpus.

The computer-implemented method may include upsampling of the picture (e.g., constructed response 306) of the residential pool 102 using a non-linear fully connected network 104 to produce only global details of an upsampled image (e.g., constructed response 306). The computer-implemented method may interpolate a resulting image to produce a smooth upsampled image (e.g., constructed response 306). The computer-implemented method may concatenate the global details and the smooth upsampled image (e.g., constructed response 306) into a tensor. The computer-implemented method may apply a sequence of nonlinear convolutions to the tensor using a convolutional neural network 104 to produce the upsampled image (e.g., constructed response 306). The steps of the method may be performed by a processor 314.

The fully connected network 104, an interpolation, and a convolution may be concurrently trained to reduce an error between upsampled set of images (e.g., constructed response 306) and corresponding set of high-resolution images. The fully connected network 104 may be a neural network 104. The training may produce weights for each neuron of the neural network 104. The interpolation may use different weights for interpolating different pixels of the image (e.g., constructed response 306). The training may produce the different weights of the interpolation. The training may produce weights for each neuron of the sequence of nonlinear convolutions. The computer-implemented method may further include padding each nonlinear convolution in the sequence to the resolution of the upsampled image (e.g., constructed response 306).

In yet another embodiment, a computer system (e.g., processing system 100) measuring a quality of ownership (e.g., quality of ownership score 108) of a residential pool using a processor 314 and a memory 312. The instructions stored in the memory 312 configure the processor 314 receives a constructed response 306 generated by a user (e.g., interested party 302). The constructed response 306 is based on a picture (e.g., constructed response 306) of the residential pool 102. The instructions stored in the memory 312 configure the processor 314 parses the constructed response 306 with a processing system 100 to generate a set of individual characteristics (e.g., design characteristics 308) associated with the constructed response 306. The instructions stored in the memory 312 configure the processor 314 to process the constructed response 306 with the processing system 100 to identify in the constructed response 306 a plurality of multi-word sequences, each multi-word sequence.

The instructions stored in the memory 312 configure the processor 314 to process the constructed response 306 with the processing system 100 to determine a first numerical measure indicative of a presence of one or more quality of ownership scores 108 in the constructed response 306. The instructions stored in the memory 312 configure the processor 314 to process the set of individual characteristics (e.g., design characteristics 308) and a reference corpus with the processing system 100 to determine a second numerical measure indicative of a degree to which the constructed response 306 describes a subject matter of the picture (e.g., constructed response 306). Each word of the set of individual characteristics (e.g., design characteristics 308) is compared to individual words of the reference corpus to determine the second numerical measure. The reference corpus is designated as representative of the subject matter.

The instructions stored in the memory 312 configure the processor 314 to process the plurality of multi-word sequences of the constructed response 306 and an comparable pool dataset (e.g., historical database 316) includes a plurality of entries with the processing system 100 to determine a third numerical measure indicative of a degree of pool (e.g., residential pool 102) irregularity factors in the constructed response 306. Each of the multi-word sequences of the constructed response 306 is searched across the entries of the comparable pool dataset (e.g., historical database 316) to determine the third numerical measure. Each entry of the comparable pool dataset (e.g., historical database 316) includes an English word n-gram and an associated statistical association score (e.g., quality of ownership score 108 and PF classification 106). The searching of each multi-word sequence includes comparing the multi-word sequence of the constructed response 306 to English word n-grams of the comparable pool dataset (e.g., historical database 316) to determine a matching entry of the comparable pool dataset (e.g., historical database 316). The statistical association score (e.g., quality of ownership score 108 and PF classification 106) for the matching entry indicating a probability of the multi-word sequence appearing in a well-formed text.

The instructions stored in the memory 312 configure the processor 314 applies a numerical computer-based scoring model (e.g., score generator 320) to the first numerical measure, the second numerical measure, and the third numerical measure to automatically determine a quality of ownership score 108 for the constructed response 306 indicative of a desirability of the residential pool 102. The quality of ownership score 108 based on a defined set of state-of-art technologies then available. The numerical computer-based scoring model (e.g., score generator 320) includes a first variable and an associated first weighting factor, the first variable receiving a value of the first numerical measure, a second variable and an associated second weighting factor, the second variable receiving a value of the second numerical measure, and a third variable and an associated third weighting factor, the third variable receiving a value of the third numerical measure.

The instructions stored in the memory 312 configure the processor 314 automatically evaluates a design of the residential pool 322 through the numerical computer-based scoring model (e.g., score generator 320). The design (e.g., design characteristics 308) includes finishes 400, plumbing 402, safety standards, maintenance parameters, and/or mechanical features in relation to a defined set of state-of-art technologies then available.

The computer system (e.g., processing system 100) may measure the quality of ownership (e.g., quality of ownership score 108) of the residential pool 102 using the processor 314 and the memory 312. The instructions stored in the memory 312 may configure the processor 314 to process the set of individual characteristics (e.g., design characteristics 308) and a pool image database (e.g., historical database 316) to generate an expanded set of individual characteristics (e.g., design characteristics 308), the expanded set includes synonyms, hyponyms, and/or hypernyms of the individual words. The instructions stored in the memory 312 may configure the processor 314 to process the reference corpus and the pool image database (e.g., historical database 316) to generate an expanded reference corpus, the expanded reference corpus includes synonyms, hyponyms, and/or hypernyms of individual words included in the reference corpus.

The instructions stored in the memory 312 may configure the processor 314 to determine a first metric for the constructed response 306, the first metric indicating a percentage of words of the set of individual characteristics (e.g., design characteristics 308) that are included in the reference corpus. The instructions stored in the memory 312 may configure the processor 314 to determine a second metric for the constructed response 306, the second metric indicating a percentage of words of the expanded set of individual characteristics (e.g., design characteristics 308) that are included in the expanded reference corpus.

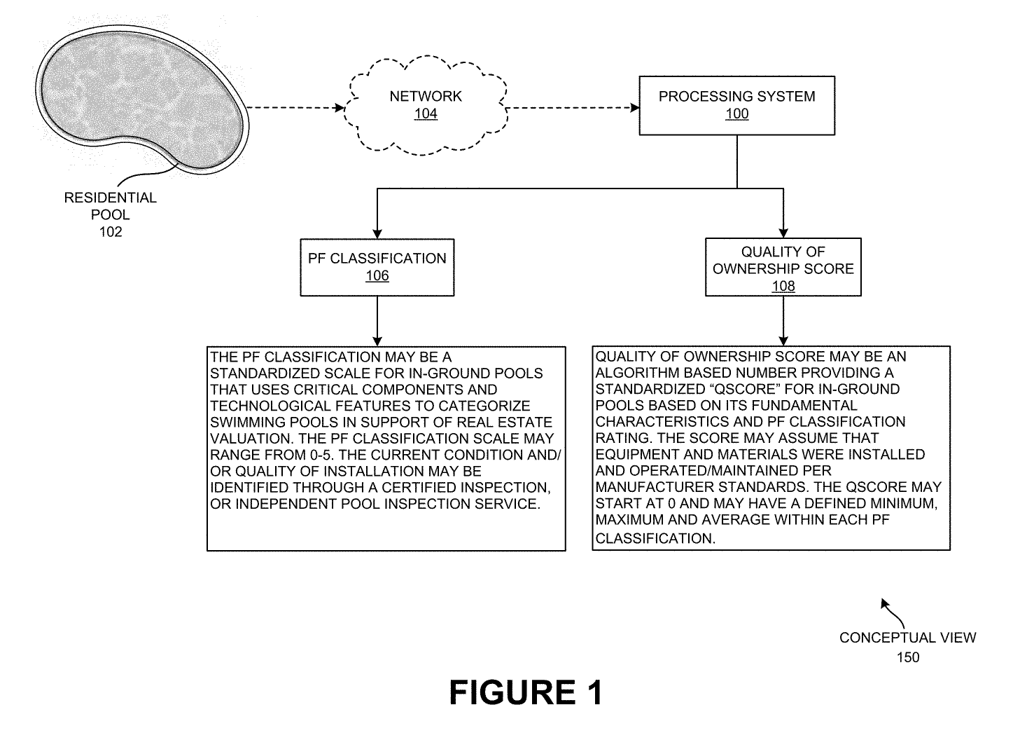

FIG. 1 is a conceptual view 150 of a processing system 100 to identify a PF classification 106 and generate a quality of ownership score 108 for a residential pool 102, according to one embodiment. Particularly, FIG. 1 illustrates a processing system 100, a residential pool 102, a network 104, a PF classification 106, and a quality of ownership score 108, according to one or more embodiments.

The processing system 100 may be a server that receive and process the constructed response 306 generated by an interested party 302 to calculate the quality of ownership score 108 and identify the PF classification 106 of the residential pool 102. The processing system 100 may receive the constructed response 306 generated by the interested party 302 through the network 104. The processing system 100 may include a memory 312, a processor 314, an image recognition algorithm 318, and a score generator 320. The processing system 100 may evaluate a design of the residential pool 322 using the image recognition algorithm 318 of the processor 314. The processor 314 and the score generator 320 of the processing system 100 may calculate the quality of ownership score 108 and identify the PF classification 106 of the residential pool 102 based on the received constructed response 306, according to one embodiment.

The processing system 100 may identify the different equipment (e.g., plumbing 402, filter 404, pump 406, multiport valve 408, skimmer 410, regulation and control equipment 412, heater 414, dosing pump 416, inlet nozzle 418, automatic pool cleaner 420, hose 422, main drain 424 etc.) installed in the residential pool 102 based on the analysis of the pictorial data (e.g., using pictorial data analysis module 310). The processing system 100 may fetch a set of technical parameters of the residential pool 102 based on the analysis of the pictorial data (e.g., using pictorial data analysis module 310). The processing system 100 may generate a numerical score (e.g., PF classification 106 and quality of ownership score 108) to inform the interested party 302 about relative quality of ownership based on the defined set of state-of-art technologies available. The processing system 100 may communicate the numerical score (e.g., PF classification 106 and quality of ownership score 108) to the interested party 302 through the network 104. The processing system 100 may further include creating 3D model of pool structure (e.g., shape of residential pool 702) using edge detection technique of the image recognition algorithm 318. The processing system 100 may provide recommendations for maintenance of the residential pool 102 based on the analysis of the pictorial data (e.g., using pictorial data analysis module 310), according to one embodiment.

The residential pool 102 may be a structure filled with fluid (e.g., water) to enable swimming and/or other leisure activities. The residential pool 102 may have installed different equipment (e.g., plumbing 402, filter 404, pump 406, multiport valve 408, skimmer 410, regulation and control equipment 412, heater 414, dosing pump 416, inlet nozzle 418, automatic pool cleaner 420, hose 422, main drain 424 etc.) in it. The residential pool 102 may have unique shape (e.g., shape of residential pool 702), dimensions (e.g., length 704, width 706 and depth 708), finish (e.g., finishes 400), and/or plumbing 402. The residential pool 102 may be an in -ground pool and/or an above ground pool. The residential pool 102 may be located at various locations (e.g., residential property 300) such as home, hotel, water park, etc. The residential pool 102 may be a private pool, a public pool, a competition pool, and/or swimming pool, according to one embodiment.

The network 104 may be a medium that allows the computing device 304 and the processing system 100 to link together through wireless communication channel to facilitate communication between them. The PF classification 106 may be a standardized scale for the residential pool 102 that uses critical components and technological features to categorize the residential pool 102 in support of real estate valuation. The PF classification 106 scale may range from 0 to 5. The current condition and/or quality of installation may be identified through the PF classification 106. The PF classification 106 may depend on the quality of ownership score 108 of the residential pool 102, according to one embodiment.

The quality of ownership score 108 may be a number providing a standardized rating for the residential pool 102 calculated by the score generator 320 of the processing system 100. The quality of ownership score 108 may be based on equipment installed and maintenance carried out per manufacturer standards. The quality of ownership score 108 may start at 0 and may have a defined minimum, maximum and/or average score within each PF classification 106, according to one embodiment.

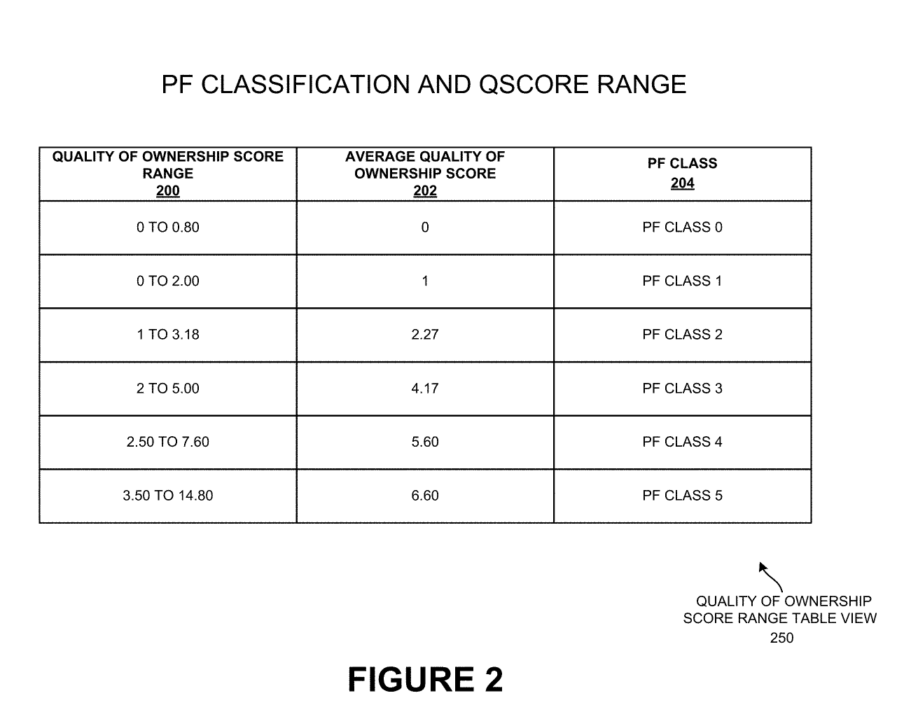

FIG. 2 is a quality of ownership score range table view 250 of the residential pool 102 of FIG. 1, according to one embodiment. Particularly, FIG. 2 shows a quality of ownership score range 200, an average quality of ownership score 202, and a PF class 204, according to one embodiment.

The quality of ownership score range 200 may be an estimate of the residential pool 102 parameters to indicate minimum and maximum quality of ownership score 108 for the particular PF class 204. The score generator 320 of the processing system 100 may assign the PF class 204 based on the calculated quality of ownership score 108 of the residential pool 102. For example, if the calculated quality of ownership score 108 for a particular residential pool 102 has the quality of ownership score range 200 between 1 to 3.18 then the score generator of the processing system 100 may assign the PF class 2 to that residential pool 102. The quality of ownership score range 200 may be predefined for each of the PF class 204, according to one embodiment.

The average quality of ownership score 202 may be a mean of minimum and maximum quality of ownership score 108 for the particular PF class 204. The PF class 204 may be a number that categorize the residential pool 102. The PF Class 204 may categorize the residential pool 102 between six PF classes (e.g., PF class 0 to PF class 5). The PF class 204 may be categorized based on the calculated quality of ownership score 108 of the residential pool 102, according to one embodiment.

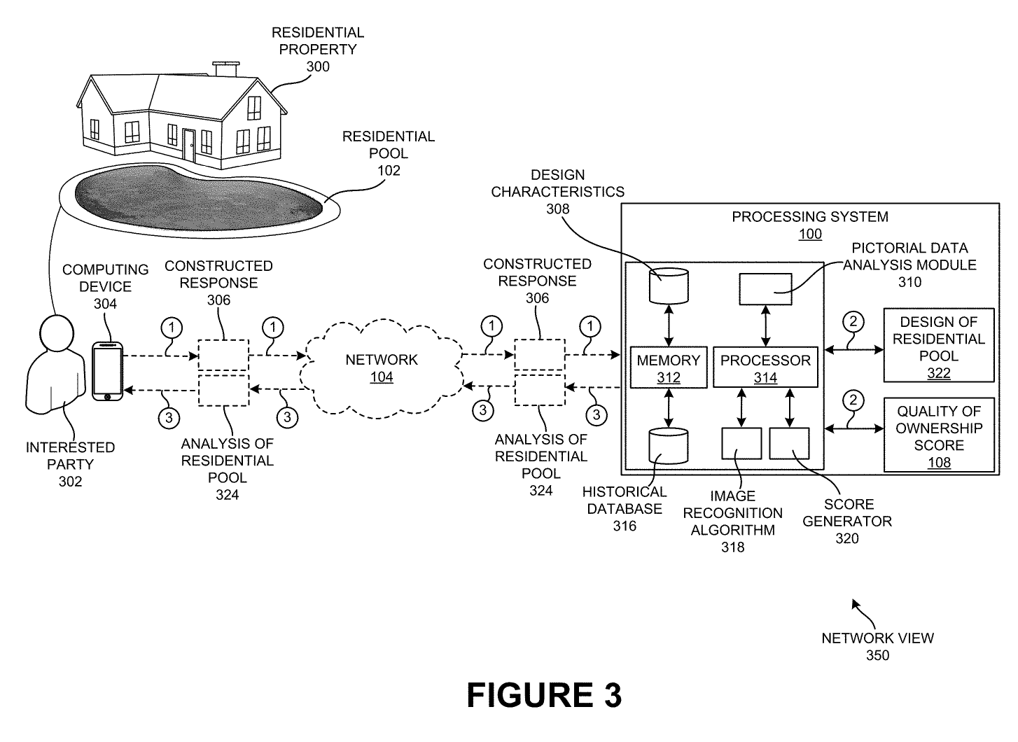

FIG. 3 is a network view 350 of the processing system 100 of FIG. 1 receiving an analysis 324 request of the residential pool 102 sent by an interested party 302 and communicating the analysis 324 based on generated result, according to one embodiment. Particularly, FIG. 3 shows a residential property 300, an interested party 302, a computing device 304, a constructed response 306, a design characteristics 308, a pictorial data analysis model 310, a memory 312, a processor 314, a historical database 316, an image recognition algorithm 318, a score generator 320, a design of residential pool 322, and an analysis of residential pool 324, according to one embodiment.

The residential property 300 may be a place of dwelling which has the residential pool 102. The residential property 300 may be a home, a hotel and/or a water park, etc. The interested party 302 may be a person who wishes to analyze the residential pool of his/her residential property 300. The interested party 302 may capture the pictures (e.g., constructed response 306) of the residential pool 102 from different angles covering the whole residential pool 102. The interested party 302 may capture the pictures (e.g., constructed response 306) of the different equipment installed in the residential pool 102, according to one embodiment.

The interested party 302 may send the captured pictures (e.g., constructed response 306) of the residential pool 102 to the processing system 100 using the computing device 304 to receive the full analysis of the residential pool 324. The interested party 302 may receive the analysis of the residential pool 324 calculated by the processing system 100 based on the captured pictures (e.g., constructed response 306) of the residential pool 102. The interested party 302 may be a buyer, a homeowner, a prospective buyer, a resident, and/or a seller of the residential pool 102, according to one embodiment.

The computing device 304 may be any handheld electronic equipment use to communicate the data (e.g., constructed response 306 and analysis of residential pool 324) to the processing system 100, through the network 104. The computing device 304 may be able to capture the pictures (e.g., constructed response 306) of the residential pool 102. The computing device 304 may be operated by the interested party 302. The computing device 304 may be a smartphone, a tablet, and/or an iPhone etc., according to one embodiment.

The constructed response 306 may be a collection of pictures of the residential pool 102 communicated by the interested party 302 to the processing system 100 in order to receive the analysis of residential pool 324. The constructed response 306 may be the pictures of the residential pool 102 with different angles covering the whole residential pool 102. The constructed response 306 may also include the pictures of the different equipment installed in the residential pool 102. The constructed response 306 may be processed by the processing system 100 to fetch the set of technical parameters of the residential pool 102. The set of technical parameters may include the manufacturing details (e.g., capacity, power, efficiency, material, etc.) of the different equipment installed, according to one embodiment.

The constructed response 306 may be processed through the processing system 100 to identify a shape 702, a length 704, a width 706, a depth 708, a linear finish (e.g., pool finishes 714), flooring (e.g., type of flooring 712), a plumbing 402, a set of electrical equipment 716, a drain location (e.g., main drain 424), an overflow pipe location, and a handrail location of the residential pool 102. The design characteristics 308 may be the features associated with the residential pool 102. The design characteristics 308 may include finishes 400, plumbing 402, safety standards, maintenance parameters and mechanical features in relation to a defined set of state-of-art technologies available, according to one embodiment.

The pictorial data analysis module 310 may be a program that inspect the constructed response 306 received by the processing system 100. The pictorial data analysis module 310 may inspect the constructed response 306 to fetch the set of technical parameters of the residential pool 100. The pictorial data analysis module 310 may inspect the constructed response 306 to identify the shape (e.g., shape of the residential pool 702) and dimensions (e.g., length 704, width 706, and depth 708), a linear finish (e.g., pool finishes 714), flooring (e.g., type of flooring 712), plumbing 402, a set of electrical equipment 716, a drain location (e.g., main drain 424), an overflow pipe location, and a handrail location of the residential pool 102. The pictorial data analysis module 310 may be coupled with the image recognition algorithm 318 through the processor 314 to evaluate the design of the residential pool 322, according to one embodiment.

The memory 312 may be a computer hardware device used to store information for immediate use of the processing system 100. The processor 314 may be a logic circuitry that responds to and processes the basic instructions that drives the processing system 100. The processor 314 may be coupled with the pictorial data analysis module 310, the image recognition algorithm 318 and score generator 320. The processor 314 may advance the analyzed pictorial data (e.g., using pictorial data analysis module 310) to evaluate the design of residential pool 322 using the image recognition algorithm 318. Further, the processor 314 may advance the analyzed pictorial data (e.g., using pictorial data analysis module 310) to calculate the quality of ownership score 108 of the residential pool 102 using the score generator 320, according to one embodiment.

The historical database 316 may be an organized collection of the data in the memory 312 of the processing system 100 accessed by the interested party 302 through the network 104. Particularly, the historical database 316 may consist of data of the residential pools 102 which were analyzed by the processing system 100 through the network 104. The historical database 316 may be a pool image database. The processor 314 may scan the historical database 316 to verify if the same residential pool 102 (e.g., for which analysis request is received) was analyzed before. The historical database 316 may be updated each time after sending the analysis of the residential pool 324, according to one embodiment.

The image recognition algorithm 318 may be the process of identifying and detecting an object and/or a feature in the picture (e.g., constructed response 306) of the residential pool 102. The image recognition algorithm 318 may be coupled with processor 314 of the processing system 100. The image recognition algorithm 318 may be coupled with the score generator 320 through processor 314 to calculate the quality of ownership score 108 of the residential pool 102. The image recognition algorithm 318 may analyze the pictorial data (e.g., constructed response 306) of the residential pool 102 to evaluate the design of residential pool 322, according to one embodiment.

The image recognition algorithm 318 may identify and detect location of the different equipment installed in the residential pool. The image recognition algorithm 318 may identify a shape 702, a length 704, a width 706, a depth 708, a linear finish (e.g., pool finishes 714), flooring (e.g., type of flooring 712), a plumbing 402, a set of electrical equipment 716, a drain location (e.g., main drain 424), an overflow pipe location, and a handrail location of the residential pool 102. The image recognition algorithm 318 may fetch a set of technical parameters of the residential pool 102 based on the analysis of the pictorial data (e.g., using pictorial data analysis module 310) with a library of known pools (e.g., residential pool 102), according to one embodiment.

The score generator 320 may be a module to calculate the standardized rating (e.g., PF classification 106 and quality of ownership score 108) for the residential pool 102. The score generator 320 may be coupled with the processor 314 to calculate the quality of ownership score 108 of the residential pool 102 using image recognition algorithm 318. The score generator 320 may assign the PF Class 204 to the residential pool 102 based on the quality of ownership score 108 of the residential pool 102, according to one embodiment.

The design of residential pool 322 may be the layout of the residential pool 102 including the shape (e.g., shape of residential pool 702) and the locations of different equipment installed in the residential pool 102. The design of residential pool 322 may be evaluated based on pictorial data analysis (e.g., using pictorial data analysis module 310) and the image recognition algorithm 318 of the processing system 100. The design of residential pool 322 may further indicate the type of flooring 712, finishing (e.g., pool finishes 714) of the residential pool 102, and the equipment (e.g., electrical equipment 716) installed in the residential pool 102, according to one embodiment.

The analysis of residential pool 324 may be an outcome of the processing system 100 after systematic examination and evaluation of the constructed response 306 communicated by the interested party 302. The analysis of residential pool 324 may be calculated by the processing system 100. The analysis of residential pool 324 may include the combination of the design of residential pool 322, the quality of ownership score 108 and the PF classification 106 of the residential pool 102. The analysis of residential pool 324 may be transmitted by the processing system 100 to the computing device 304 of the interested party 302, through the network 104, according to one embodiment.

FIG. 3 illustrates a number of operations between the computing device 304, the network 104 and the processing system 100. Particularly, circle ‘1’ of FIG. 3 illustrates the constructed response 306 being communicated from the computing device 304 of the interested party 302 to the processing system 100 through the network 104. The circle ‘2’ shows evaluation of the design (e.g., design of residential pool 322) and calculation of the quality of ownership score 108 of the residential pool 102 based on the received constructed response 306 in the processing system 100. The circle ‘3’ illustrates the analysis of residential pool 324 being transmitted from processing system 100 to the computing device 304 of the interested party 302 through the network 104, according to one embodiment.

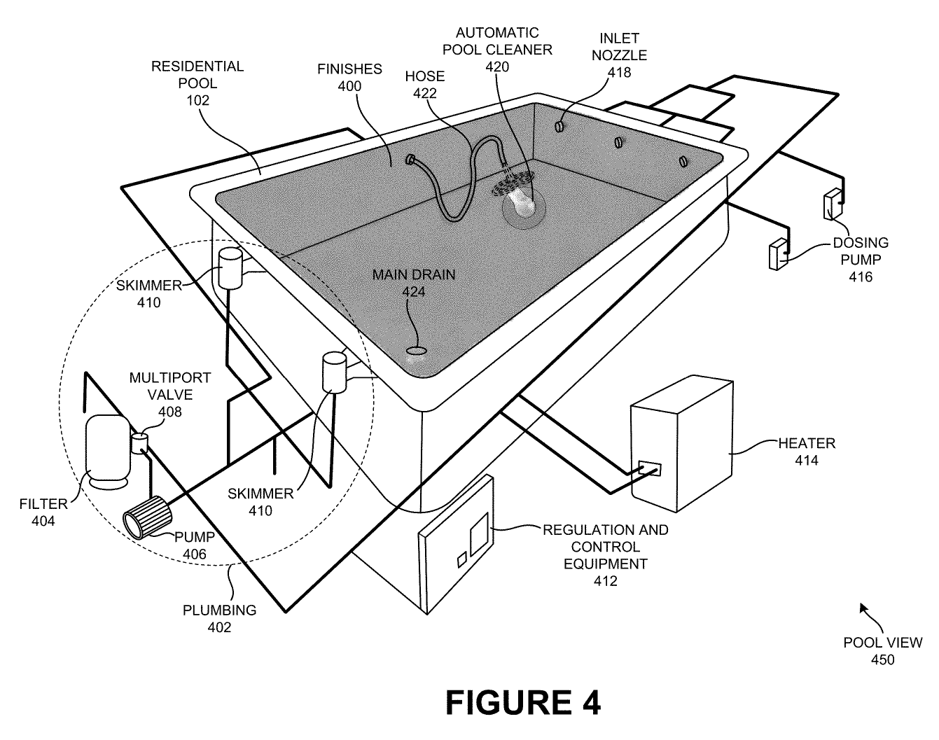

FIG. 4 is an overview 450 of the residential pool 102 system of FIG. 1, according to one embodiment. Particularly, FIG. 4 shows a finishes 400, a plumbing 402, a filter 404, a pump 406, a multiport valve 408, a skimmer 410, a regulation and control equipment 412, a heater 414, a dosing pump 416, an inlet nozzle 418, an automatic pool cleaner 420, a hose 422, and a main drain 424, according to one embodiment.

The finishes 400 may be an internal coating of the residential pool 102. The finishes 400 may be plaster finish, aggregate finish, and/or exposed aggregate etc. The finishes 400 may have different array of materials, colors, and/or textures. The plumbing 402 may be an internal system concerned in the distribution and usage of fluid (e.g., water) in the residential pool 102. The applications of plumbing 402 may include waste removal, heating and/or cooling of water. The plumbing 402 may include the filter 404, the pump 406, the multiport valve 408, and the skimmer 410. The filter 404 may be a device for removing impurities and/or solid particles from the fluid (e.g., water) of the residential pool 102 passed through it, according to one embodiment.

The pump 406 may be a device to raise, transfer, and/or deliver the fluid (e.g., water) in the residential pool 102, using suction and/or pressure. The multiport valve 408 may be an equipment to allow the fluid (e.g., water) to move in multiple directions, depending on the handle position of the multiport valve 408. The multiport valve 408 may be installed next to the pump 406 and the filter 404. The multiport valve may be a vari-flo valve, backwash valve, and/or filter control valve. The multiport valve 408 may be operated on filter position, waste position, closed position, backwash position, recirculate position, rinse position, and/or winter position, according to one embodiment.

The skimmer 410 may be a device and/or apparatus to clean the water by capturing floating debris like leaves, flower petals, dirt, twigs, dead insects, and oil. The skimmer 410 may suck water out of the residential pool 102 through the filter system. The skimmer 410 may be installed at the sides of the residential pool 102 and/or near the top of the water level of the residential pool 102. The residential pool 102 may have multiple skimmers 410 installed, depending on the size of the residential pool 102. The regulation and control equipment 412 may be an apparatus to operate the different equipment (e.g., electrical equipment 716) in the residential pool 102, according to one embodiment.

The heater 414 may be an equipment to raise the temperature of the water in the residential pool 102. The dosing pump 416 may be a small displacement pump designed to supply a very precise flow rate of a chemical and/or substance into the water of the residential pool 102. The dosing pump 416 may be fitted with a chemical tank. The inlet nozzle 418 may be a fluid (e.g., water) delivery point of the residential pool 102 to distribute the filtered and treated water. The inlet nozzle 418 may be positioned at wall and/or the floor of the residential pool 102, according to one embodiment.

The automatic pool cleaner 420 may be a vacuum cleaner intended to collect debris and sediment from the residential pool 102 with minimal human intervention. The hose 422 of the automatic pool cleaner 420 may be a flexible tube for conveying fluid (e.g., water). The main drain 424 may be an outlet to help the residential pool 102 to process all the water in an efficient manner. The main drain 424 may be positioned at the deepest point of the residential pool 102, according to one embodiment.

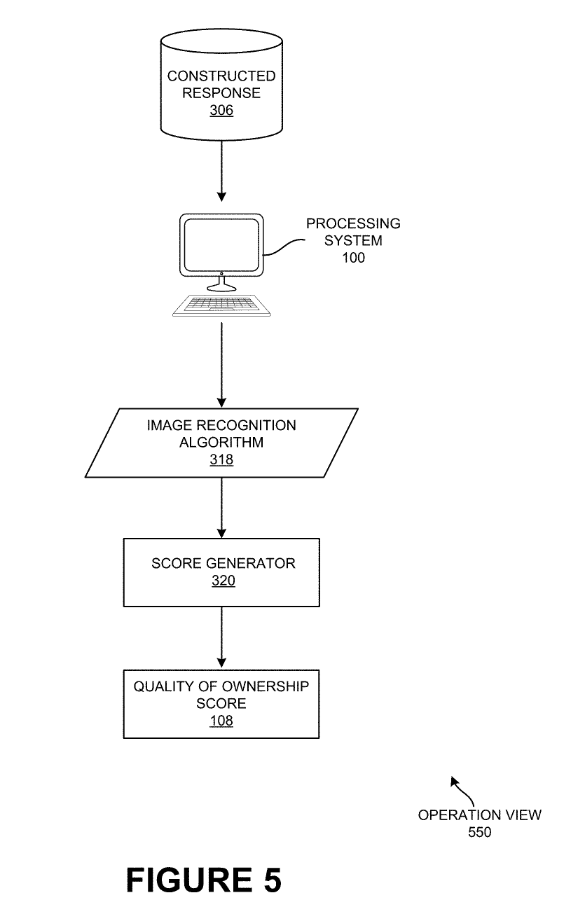

FIG. 5 is an operational view 550 of the processing system 100 of FIG. 1 to generate the quality of ownership score 108, according to one embodiment. FIG. 5 illustrates the constructed response 306 generated by the user (e.g., interested party 302) is transmitted to the processing system 100 through a network 104. The processing system 100 may have the image recognition algorithm 318 and the score generator 320. The constructed response 306 received by the processing system 100 may be processed through the image recognition algorithm 318 to evaluate the design (e.g., design of residential pool 322) and identify the equipment (e.g., electrical equipment 716) installed in the residential pool 102. The score generator 320 of the processing system 100 may evaluate the quality of ownership score 108 of the residential pool 102 based on the equipment (e.g., electrical equipment 716) installed and features (e.g., design characteristics 308) of the residential pool 102. The score generator 320 may further determine the PF classification 106 of the residential pool 102 based the evaluated quality of ownership score 108 of the residential pool 102, according to one embodiment.

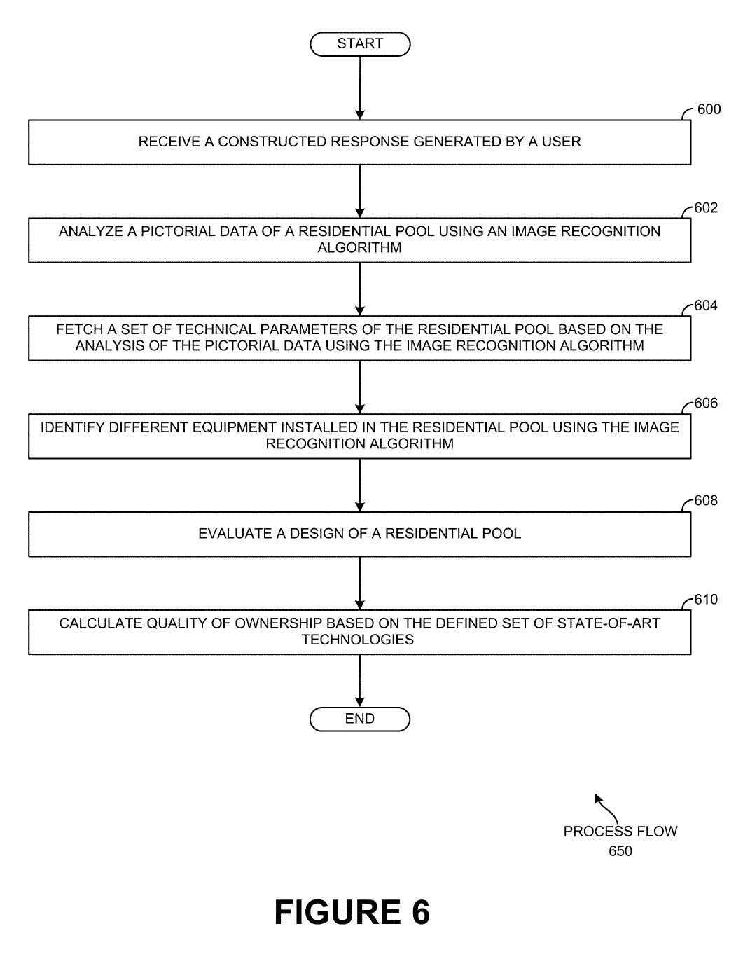

FIG. 6 is a process flow 650 detailing the operations involved in evaluating a design (e.g., design of residential pool 322) and calculating the quality of ownership score 108 of the residential pool 102 of FIG. 1, according to an embodiment. In operation 602, a processing system 100 may analyze a pictorial data (e.g., constructed response 306) of a residential pool 102 using an image recognition algorithm 318. In operation 604, the processing system 100 may fetch a set of technical parameters of the residential pool 102 based on the analysis of the pictorial data (e.g., using pictorial data analysis module 310) using the image recognition algorithm 318. In operation 606, the processing system 100 may identify different equipment (e.g., electrical equipment 716) installed in the residential pool 102 using the image recognition algorithm 318. In operation 608, the processing system 100 may evaluate a design of the residential pool 322. In operation 610, the processing system 100 may calculate quality of ownership score 108 based on the defined set of state-of-art technologies, according to one embodiment.

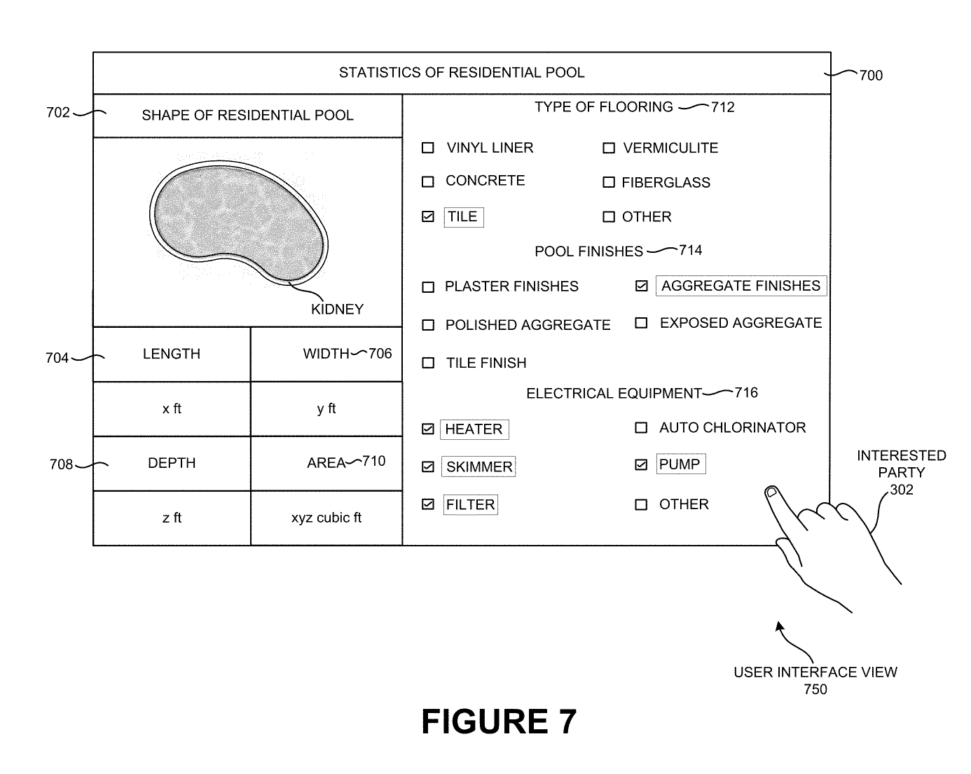

FIG. 7 is a user interface view 750 displaying the statistics of the residential pool 700 of FIG. 1 received to a computing device 304 of the interested party 302, according to one embodiment. Particularly, FIG. 7 shows a statistics of residential pool 700, a shape of residential pool 702, a length 704, a width 706, a depth 708, an area 710, a type of flooring 712, a pool finishes 714, and electrical equipment 716, according to one embodiment.

The statistics of residential pool 700 may be the presentation of analysis of residential pool 324 received by the computing device 304 of the interested party 302. The statistics of residential pool 700 may be calculated and/or evaluated by the processing system 100. The statistics of residential pool 700 may display the shape 702, the length 704, the width 706, the depth 708, the area 710, the type of flooring 712, the pool finishes 714, and the electrical equipment 716 of the residential pool. The statistics of residential pool 700 may further display the PF classification 106, the quality of the ownership score 108 and other features of the residential pool 102, according to one embodiment.

The shape of residential pool 702 may be an external form of the residential pool 102. The shape of the residential pool 702 may be evaluated and identified at the pictorial data analysis module 310 and the image recognition algorithm 318 of the processing system 100. The shape of the residential pool 702 may have an oval shape, a rectangle shape, a kidney shape, a figure 8 shape, a grecian shape and/or other shapes. The shape of residential pool 702 may be displayed on the computing device 304 of the interested party 302, according to one embodiment.

The length 704, the width 706, and the depth 708 may be the dimensions of the residential pool 102 analyzed by the image recognition algorithm 318 and the pictorial data analysis module 310 of the residential pool 102. The area 710 of the residential pool 102 may be calculated based on analyzed length 704, width 706, and depth 708 of the residential pool 102. The length 704, width 706, depth 708 and area 710 may be displayed on the computing device 304 of the interested party 302, according to one embodiment.

The type of flooring 712 may be the kind of material of which a floor of the residential pool 102 is made. The type of flooring 712 may be identified at the pictorial data analysis module 310 of the processing system 100. The type of flooring 712 may be vinyl liner flooring, vermiculite flooring, concrete flooring, fiberglass flooring, tile flooring and/or other types of flooring 712 of the residential pool 102. The type of flooring 712 may be displayed on the computing device 304 of the interested party 302, according to one embodiment.

The pool finishes 714 may be the interior finish of the residential pool 102. The pool finishes 714 may be identified at the pictorial data analysis module 310 of the processing system 100. The residential pool 102 may have plaster finishes, aggregate finishes, polished aggregates, exposed aggregates, tile finish and/or other types of pool finishes 714. The pool finishes 714 may be displayed on the computing device 304 of the interested party 302, according to one embodiment.

The electrical equipment 716 may be a set of hardware installed for maintenance of the residential pool 102. The electrical equipment 716 may be identified at the pictorial data analysis module 310 of the processing system 100. The electrical equipment 716 may include a heater 414, a skimmer 410, an auto chlorinator, a pump 406, a filter 404, and/or other electrical equipment 716 of the residential pool 102. The parameters of the electrical equipment 716 may be displayed on the computing device 304 of the interested party 302, according to one embodiment.

In a further embodiment, the rating (e.g., PF classification 106 and quality of ownership score 108) submission process of the residential pool 102 system may include the interested party 302 (e.g., home inspectors and realtors) subscribing to a processing system 100 to submit the web based form to get PF classification 106 and the quality of ownership score 108 of the residential pool 102. The interested party 302 (e.g., home inspectors and realtors) may request processing system 100 along with 5 pictures (e.g., constructed response 306) of the pool (3 for equipment and 2 for pool views) to get the PF classification 106 and the quality of ownership score 108. Once the request (e.g., constructed response 306) is submitted the processing system 100 may run the appropriate calculator (e.g., score generator 320) based on the residential pool's 102 features, and researches the existing market around the residential pool 102 for any comparison data. The results (e.g., analysis of residential pool 324) of the requested residential pool 102 may be uploaded into the historical database 316 of the processing system 100. If the requested residential pool 102 is already in the historical database 316 of the processing system 100, then the processing system 100 may update the residential pool 102 data (e.g., historical database 316) with current results (e.g., analysis of residential pool 324).

The processing system 100 may allow the interested party 302 to identify market average classifications (e.g., PF classification 106) and the quality of ownership scores 108 by zip code, homeowner's association and/or housing communities. The processing system 100 may establish the PF classification 106 and the quality of ownership score 108 as a standard for residential real estate appraisals, BPO's and bank financing criteria for home loans and equity financing. The processing system 100 may have a web app plug-in for realtors (e.g., interested party 302) to incorporate into their personal website for clients to run unofficial classifications (e.g., PF classification 106) & the quality of ownership scores 108 and notify realtors (e.g., interested party 302) as well as the processing system 100 with a request for additional guidance on making renovations. The processing system 100 may allow the interested party 302 to access the database (e.g., historical database 316) to provide pool builder and/or pool designer measurability information (e.g., a builder's average (e.g., average quality of ownership score 202), max and minimum PF class (e.g., quality of ownership score range 200) and the quality of ownership score 108 for projects they have built).

In addition, the processing system 100 may integrate image recognition (e.g., image recognition algorithm 318) technology (take a picture of the front of a residential property 300) and/or geolocation technology within the processing system 100 search feature to allow the interested party 302 to access the residential pool's PF class 204 and the quality of ownership score 108 summary. The PF class 204 and the quality of ownership score 108 summary may include the realtor partner of record.

The processing system 100 may include residential property 300 with the residential pool 102 plan on file that hasn't been built yet to determine if the residential property 300 can incorporate the residential pool 102 later and what the current plans on file have as a PF class 204 and the quality of ownership score 108 rating. The processing system 100 may identify additional information such as history of maintenance and remodeling to aid in their home buying selection process, including any proposed improvements that could increase the residential pool's PF class 204 and the quality of ownership score 108 cost effectively.

The residential property 300 in the historical database 316 may provide private portal access into the residential property's 300 account for the current property owner. The processing system 100 may allow the interested party 302 to conduct a periodic review of current PF class 204 and the quality of ownership score 108, comparable market averages in surrounding community (e.g., by mile radius) including the average proposed improvements for the same area. The processing system 100 may allow the interested party 302 to access the recommendations for improvements (e.g., equipment upgrades, remodeling options, etc.) that the processing system 100 may automatically generate as the manufacturer introduces new control technologies, equipment (e.g., electrical equipment 716) and finishes (e.g., pool finishes 714) into the market and supply product information into historical database 316.

The interested party 302 may select the upgrade indicator to the PF calculator (e.g., score generator 320) field where the interested party 302 may consider an improvement and the PF calculator (e.g., score generator 320) field may automatically generate the score improvements and provide a list of options to achieve the desired changes. The interested party 302 may predict the impact on their residential pool's PF class 204 and the quality of ownership score 108 for future marketability decisions, and/or quality of ownership improvements for their personal benefit, while setting a general budget.

The interested party 302 may have access to brief product education about the technologies to improve their PF class 204 and the quality of ownership score 108, as well as establish a base line cost for making these improvements to utilize in their contractor shopping process should they wish to purchase the improvements. The interested party 302 may use the processing system 100 interface to connect the equipment manufacturers', material manufacturers' product data, the CRM and project management software to supply the processing system 100 information for the respective residential property 300.

The fundamental classification may be 0 to 3 based on the residential pool 102 and/or the residential pool design (e.g., design of residential pool 322). The most critical components for quality of ownership, convenience, and remote monitoring support may include pool controls & automation, variable speed pump technology, and in-floor cleaning system. Each classification (e.g., PF classification 106) section may have the weighted aspects to contribute the residential pool's quality of ownership score 108. The class 4 may be based on the interior finish (e.g., finishes 400) of the residential pool 102, which may contribute to a class (e.g., PF class 204) increase only if the residential pool 102 has a class 3 rating. Otherwise, only the class 4 weighted factors may contribute to the residential pool's overall quality of ownership score 108 rating.

The quality of ownership score 108 impact may be reduced when the residential pool 102 does not meet a class 5 designation. The class 5 may be based on the residential pool 102 having additional water features to expand the functionality of the residential pool 102 for broader family enjoyment. As with class 4 rating, if the residential pool 102 has the class 5 feature but does not qualify as the class 4 rating, then the only it's class 5 weighted factors may contribute to the residential pools' overall the quality of ownership score 108 rating. The quality of ownership score 108 impact may be reduced when the residential pool 102 does not meet the class 5 designation.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method comprising:
automatically evaluating a design of a residential pool through an image recognition algorithm,
wherein the design includes at least one of finishes, plumbing, safety standards, maintenance parameters and mechanical features in relation to a defined set of state-of-art technologies then available; and
generating a numerical score to inform an interested party about relative quality of ownership based on the defined set of state-of-art technologies then available.

2. The method of claim 1 wherein a historical database is maintained of at least one of materials, repairs, modifications and improvements during a history of the residential pool.

3. The method of claim 2 wherein the interested party is at least one of a buyer, a homeowner, a. prospective buyer, a resident, and a seller of the residential pool.

4. The method of claim 3 further comprising:
analyzing a pictorial data of the residential pool using the image recognition algorithm;
fetching a set of technical parameters of the residential pool based on the analysis of the pictorial with a library of known pools using the image recognition algorithm;
identifying different equipment installed in the residential pool using the image recognition algorithm; and
automatically identify a shape, a length, a width, a depth, a linear finish, a flooring, a plumbing, a set of electrical equipment, a drain location, an overflow pipe location, a a handrail location based on the image recognition algorithm.

5. A computer-implemented method of measuring a quality of ownership of a residential pool, the method comprising:
receiving a constructed response generated by a user, he constructed response being based on a picture of the residential pool;
parsing the constructed response with a processing system to generate a set of individual characteristics associated with the constructed response;
processing the constructed response with the processing system to identify n the constructed response a plurality of multi-word sequences, each multi-word sequence comprising a sequence of two or more adjacent words in the constructed response;
processing the constructed response with the processing system to deter determine a first numerical measure indicative of a presence of dyne or snore quality of ownership scores in the constructed response;
processing the set of individual characteristics and a reference corpus with the processing system to determine a second numerical measure indicative of a degree to which the constructed response describes a subject matter of the picture, each word of e set of individual characteristics being compared to individual words of the reference corpus to determine the second numerical measure, the reference corpus having been designated as representative of the subject matter;
processing the plurality of multi-word sequences of the constructed response and an comparable pool dataset comprising a plurality of entries with the processing system to determine a third numerical measure indicative of a degree of pool irregularity factors in the constructed response, each of the multi-word sequences of the constructed response being searched across the entries of the comparable pool dataset to determine the third numerical measure,
wherein each entry of the comparable pool dataset includes an English word n-gram and an associated statistical association score, the searching of each multi-word sequence comprising comparing the multi-word sequence of the constructed response to English word n-grams of the comparable pool dataset to determine a matching entry of the comparable pool dataset, the statistical association score for the matching entry indicating a probability of the multi-word sequence appearing in a well-formed text;
applying a numerical, computer-based scoring model to the first numerical measure, the second numerical measure, and the third numerical measure to automatically determine the quality of ownership score for the constructed response indicative of a desirability of the residential pool based on a defined set of state-of-art technologies then available, the numerical, computer-based scoring model including a first variable and an associated first weighting factor, the first variable receiving a value of the first numerical measure, a second variable and an associated second weighting factor, the second variable receiving a value of the second numerical measure, and a third variable and an associated third weighting factor, the third variable receiving a value of the third numerical measure; and
automatically evaluating a design of the residential pool through the numerical, computer -based scoring model,
wherein the design includes at least one of finishes, plumbing, safety standards, maintenance parameters and mechanical features in relation to a defined set of state-of-art technologies then available.

6. The computer-implemented method of claim 5,
wherein the determining of the second numerical measure comprises:
processing the set of individual characteristics and a pool image database to generate an expanded set of individual characteristics, the expanded set comprising synonyms, hyponyms, or hypernyms of the individual words;
processing the reference corpus and the pool image database to generate an expanded reference corpus, the expanded reference corpus comprising synonyms, hyponyms, or hypernyms of individual words included in the reference corpus;
determining a first metric for the constructed response, the first metric indicating a percentage of words of the set of individual characteristics that are included in the reference corpus; and
determining a second metric for the constructed response, the second metric indicating a percentage of words of the expanded set of individual characteristics that are included in the expanded reference corpus.

7. The computer-implemented method of claim 6 wherein a historical database is maintained of at least one of materials, repairs, modifications and improve vents during a history of the residential pool.

8. The computer-implemented method of claim 7 wherein the interested party is at east one of a buyer, a homeowner, a prospective buyer, a resident, and a seller of the residential pool.

9. The computer-implemented method of claim 8 further comprising:
analyzing a pictorial data of the residential pool using an image recognition algorithm;
fetching a set of technical parameters of the residential pool based on the analysis of the pictorial data with a library of known pools using the image recognition algorithm;
identifying different equipment installed in the residential pool using the image recognition algorithm; and
automatically identify a shape, a length, a width, a depth, a linear finish, a flooring, a plumbing, and a set of electrical equipment, a drain location, an overflow pipe location, and a handrail location based on the image recognition algorithm.

10. The computer-implemented method of claim 9 further comprising:
upsampling the picture of the residential pool using a non-linear fully connected network to produce only global details of an upsampled image;
interpolating a resulting image to produce a smooth upsampled image;
concatenating the global details and the smooth upsampled image into a tensor; and
applying a sequence of nonlinear convolutions to the tensor using a convolutional neural network to produce the upsampled image,
wherein steps of the method are performed by a processor.

11. The computer-implemented method of claim 10, wherein the fully connected network, an interpolation, and a convolution are concurrently trained to reduce an error between upsampled set of images and corresponding set of high-resolution images.

12. The computer-implemented method of claim 11, wherein the fully connected network is a neural network, and wherein the training produces weights for each neuron of the neural network.

13. The computer-implemented method of claim 12, wherein the interpolation uses different weights for interpolating different pixels of the image, and wherein the training produces the different weights of the interpolation.

14. The computer-implemented method of claim 13, wherein the training produces weights for each neuron of the sequence of nonlinear convolutions.

15. The computer-implemented method of claim 14, further comprising: padding each nonlinear convolution in the sequence to the resolution of the upsampled image.

16. A computer system measuring a quality of ownership of a residential pool using a processor and a memory, wherein the instructions stored in the memory configure the processor to:
receive a constructed response generated by a user, the constructed response being based on a picture of the residential pool;
parse the constructed response with a processing system to generate a set of individual characteristics associated with the constructed response;
process the constructed response with the processing system. to identify in the constructed response a plurality of multi-word sequences, each multi-word sequence comprising a sequence of two or more adjacent words in the constructed response;
process the constructed response with the processing system to determine a first numerical measure indicative of a presence of one or more quality of ownership scores in the constructed response;
process the set of individual characteristics and a reference corpus with the processing system to determine a second numerical measure indicative of a degree to which the constructed response describes a subject matter of the picture, each word of the set of individual characteristics being compared to individual words of the reference corpus to determine the second numerical measure, the reference corpus having been designated as representative of the subject matter;
process the plurality of multi-word sequences of the constructed response and an comparable pool dataset comprising a plurality of entries with the processing system to determine a third numerical measure indicative f a degree of pool irregularity factors in the constructed response, each of the multi-word sequences of the constructed response being searched across the entries of the comparable pool dataset to determine the third numerical measure,
wherein each entry of the comparable pool dataset includes an English word n-gram and an associated statistical association score, the searching of each multi-word sequence comprising comparing the multi-word sequence of the constructed response to English word n-grams of the comparable pool dataset to determine a matching entry of the comparable pool dataset, the statistical association score for the matching entry indicating a probability of the multi-word sequence appearing in a well-formed text;
apply a numerical, computer-based scoring model to the first numerical measure, the second numerical measure, and the third numerical measure to automatically determine a quality of ownership score for the constructed response indicative of a desirability of the residential pool based on a defined set of state-of-art technologies then available, the numerical, computer-based scoring model including a first variable and an associated first weighting factor, the first variable receiving a value of the first numerical measure, a second variable and an associated second weighting factor, the second variable receiving a value of the second numerical measure, and a third variable and an associated third weighting factor, the third variable receiving a value of the third numerical measure; and
automatically evaluate a design of the residential pool through the numerical, computer -based scoring model,
wherein the design includes at least one of finishes, plumbing, safety standards, maintenance parameters and mechanical features in relation to a defined set of state-of-art technologies then available.

17. The computer system measuring the quality of ownership of the residential pool using the processor and the memory, wherein the instructions stored in the memory configure the processor to:
process the set of individual characteristics and a pool image database to generate an expanded set of individual characteristics, the expanded set comprising synonyms, hyponyms, or hypernyms of the individual words;
processing the reference corpus and the pool image database to generate an expanded reference corpus, the expanded reference corpus comprising synonyms, hyponyms, or hypernyms of individual words included in the reference corpus;
determine a first metric for the constructed response, the first metric indicating a percentage of words of the set of individual characteristics that are included in the reference corpus; and
determining a second metric for the constructed response, the second metric indicating a percentage of words of the expanded set of individual characteristics that are included in the expanded reference corpus.

18. The computer system of claim 17 wherein a historical database is maintained of at least one of materials, repairs, modifications and improvements during a history of the residential pool.

19. The computer system of claim 18 wherein the interested party is at least one of a buyer, a homeowner, a prospective buyer, a resident, and a seller of the residential pool.

20. The computer system of measuring the quality of ownership of the residential pool using the processor and the memory of claim 19, wherein the instructions stored in the memory configure the processor to further:
analyze a pictorial data of the residential pool using an image recognition algorithm;
fetch a set of technical parameters of the residential pool based on the analysis of the pictorial data with a library of known pools using the image recognition algorithm;
identify different equipment installed in the residential pool using the image recognition algorithm; and
identify a shape, a length, a width, a depth, a linear finish, a flooring, a plumbing, and a set of electrical equipment, a drain location, an overflow pipe location, and a handrail location based on the image recognition algorithm.
